(19) United States
(12) Patent Application Publication
(10) Pub. No.: US 2011/0090172 A1
(43) Pub. Date: Apr. 21, 2011

(54) CAPACITIVE TOUCH SENSOR

(76) Inventors: Tetsuhiro KAYA, Hyogo (JP); Takashi Watanabe, Osaka (JP)

(21) Appl. No.: 12/883,251

(22) Filed: Sep. 16, 2010

(30) Foreign Application Priority Data
Oct. 16, 2009 (JP) 2009-239030

(51) Int. Cl. G06F 3/045

(52) U.S. Cl. 345/174

(57) ABSTRACT

According to the capacitive touch sensor of the present invention, the first transparent conductor patterns are positioned upper than the second transparent conductor patterns. Each of the first and the second conductor patterns has a plurality of broadened parts. Each of the broadened parts of the second transparent conductor patterns is larger in area than each of the broadened parts of the first transparent conductor patterns.

### BACKGROUND OF THE INVENTION

1. Field of the Invention

The present invention relates to a capacitive touch sensor, which is an input device built in electronic equipment including a notebook computer and a portable device, capable of receiving input from finger-touch or pen-touch operation.

2. Background Art

In recent, years, capacitive touch sensors have been popularly employed for an input device of electronic equipment, such as a notebook computer and a portable device. The capacitive touch sensor serves, for example, as a touch pad or a touch panel disposed over a display.

In response to user's finger-touch or pen-touch operation on the surface, the capacitive touch sensor detects the position from change in capacitance. Receiving the position data from the sensor, the electronic device generates an event according to the position data.

FIG. 3 is a sectional view showing a typical structure of a capacitive touch sensor. FIG. 4 shows a structure of a conductor pattern of a capacitive touch sensor.

As shown in FIG. 3, the capacitive touch sensor has a layered structure of the following components:
glass-made protective cover 1 on which the user's finger or a pen touches;
conductor pattern substrates 2 and 3, each of which is formed in a manner that a transparent conductor pattern film (electrode) made of ITO (indium tin oxide) is formed on a transparent substrate; and
transparent insulating sheet 4 disposed between conductor pattern substrates 2 and 3.

They are bonded with each other by transparent adhesive (not shown) and formed into a layered structure.

For the sake of easy understanding, the drawings show the transparent components as being visible.

As is shown in the plan view of FIG. 4, each of conductor pattern substrates 2 and 3 has a plurality of conductor patterns arranged in parallel. Substrate 2 is disposed on substrate 3 in a manner that conductor patterns 2a of substrate 2 and conductor patterns 3a of substrate 3 have an orthogonal arrangement. Each crossing position of patterns 2a and 3a represents a position on a two-dimensional surface determined by the X and Y directions.

A finger touch on the surface of protective cover 1 brings change in capacitance. Reading the change from each conductor pattern, the touch sensor detects a crossing position of the X and Y directions of the conductor patterns corresponding to the finger-touched position.

However, such structured capacitive touch sensor has a problem. As described above, the layered structure is formed of transparent components; still, each component has a difference in transparency. Therefore, there are differences in transparency in the following areas: the area with conductor patterns 2a and 3a overlapped; the area having any one of conductor patterns 2a and 3a; and the area with no conductor pattern. In particular, when the touch sensor is disposed on a display and used as a touch panel, poor uniformity in transparency causes uneven image display, degrading image quality of the display.

To address the problem above, for example, patent literature 1 has suggested an improved structure. In the structure, the conductor pattern has a partly broadened shape. Employing the conductor pattern minimizes not only the overlapped area of the two conductor patterns but also the area having no conductor pattern.

FIGS. 5A and 5B show the structure of the conductor pattern suggested above. FIG. 5A shows conductor patterns 2a and 3a in which square (diamond-shaped) parts 2b and 3b are linearly connected by narrow joint parts 2c and 3c, respectively.

FIG. 5A shows the actual shape of the conductor patterns. FIG. 5B is a schematic view of the conductor patterns, showing that the broadened part is formed into a square.

Employing the structure minimizes not only the overlapped area of the two conductor patterns but also the area having no conductor pattern, enhancing uniformity in transparency. Besides, the structure increases the area occupied with the conductor pattern, enhancing sensitivity of the touch sensor.

According to such structured conventional capacitive touch sensor, part 2b of pattern 2a and part 3b of pattern 3a have the same shape of square, that is, conductor pattern 2a and conductor pattern 3a are approximately the same in area.

However, as is apparent from the sectional view of FIG. 3, conductor pattern 3a is disposed farther than conductor pattern 2a from the surface of protective cover 1 as the top layer. The difference in distance causes variations in sensitivity between conductor pattern 2a and conductor pattern 3a, so that uniform sensitivity between in X direction and in Y direction is not expected. If the sensitivity of the sensor is reduced so as to obtain the level well-balanced between in X direction and in Y direction, the sensitivity of the conductor pattern positioned lower than the other one further decreases below a required level. As a result, the contact position cannot be detected.

The touch sensor detects the coordinate value corresponding to the finger-touched position by calculating the capacitance level between adjacent two points. The conductor patterns being responsible for detection in the Y direction are disposed on a layer lower than the conductor patterns for detection in the X direction. Therefore, there is difficulty in position detection of two points in the Y direction due to poor sensitivity of adjacent two points and small overlapped amount in capacitance level.

FIGS. 6A and 6B show changes in sensitivity in the X and Y directions, respectively, of the capacitive touch sensor. In FIG. 6A, the horizontal axis represents each sensor in response to a “swipe” (i.e. finger-sliding movement on the surface) in the X direction, and the vertical axis represents detected capacitance level (i.e. sensitivity of the sensor). Similarly, in FIG. 6B, the horizontal axis represents each sensor in response to a swipe in the Y direction, and the vertical axis represents detected capacitance level.

As shown in FIGS. 6A and 6B, capacitance level B of adjacent two points in the Y direction has overlapped amount A smaller than in the X direction. In the X direction, the coordinate value is calculated with accuracy by virtue of sufficient overlapped amount A, whereas small overlapped amount A in the Y direction results in poor accuracy in the coordinate calculation.

If conductor patterns 2a and 3a are formed on the same surface, the structure is free from the problem above. However, in such a structure, a bridge is additionally formed at an intersection of conductor patterns 2a and 3a. This invites a complex and difficult manufacturing process and further problem of breakage of the bridge.

### PATENT LITERATURE

patent literature 1: Japanese Unexamined Patent Application Publication No. 2003-511799

### SUMMARY OF THE INVENTION

The capacitive touch sensor of the present invention has a layered structure formed of a transparent upper member on which a finger or a pen touches, first transparent conductor patterns arranged in parallel, second transparent conductor patterns arranged in parallel, and a transparent insulating member disposed between the first transparent conductor patterns and the second transparent conductor patterns. The structure forms a two-dimensional sensor in a manner that the first and the second transparent conductor patterns are disposed in an orthogonal arrangement. Having the structure above, the capacitive touch sensor of the present invention has the following distinctive features:
the first transparent conductor patterns are disposed upper than the second transparent conductor patterns;
each of the first transparent conductor patterns and the second transparent conductor patterns has a plurality of broadened parts; and
each of the broadened parts of the second transparent conductor patterns is larger than that of the first transparent conductor patterns.

The structure of the capacitive touch sensor enhances uniformity not only in transparency but also in sensitivity of the conductor patterns.

### BRIEF DESCRIPTION OF THE DRAWINGS

FIG. 1A is a plan view partially showing an actual pattern shape of conductor patterns of a capacitive touch sensor in accordance with a first exemplary embodiment of the present invention.

FIG. 1B schematically shows the shape of the conductor pattern area of the capacitive touch sensor in accordance with the first exemplary embodiment.

FIG. 2 is a plan view partially showing an actual pattern shape of conductor patterns of a capacitive touch sensor in accordance with a second exemplary embodiment of the present invention.

FIG. 3 is a sectional view showing the typical structure of a conventional capacitive touch sensor.

FIG. 4 shows an example of conductor patterns of a conventional capacitive touch sensor.

FIG. 5A shows an actual pattern shape of conductor patterns of a conventional capacitive touch sensor.

FIG. 5B schematically shows the shape of the conductor patterns of a conventional capacitive touch sensor.

FIG. 6A shows change in sensitivity in the X direction in response to a sliding movement in the X direction of a conventional capacitive touch sensor.

FIG. 6B shows change in sensitivity in the Y direction in response to a “swipe” (i.e. finger-sliding movement on the surface) in the Y direction of the conventional capacitive touch sensor.

FIG. 7A shows change in sensitivity in the X direction in response to a swipe in the X direction of the capacitive touch sensor of the first, exemplary embodiment.

FIG. 7B shows change in sensitivity in the Y direction in response to a swipe in the Y direction of the capacitive touch sensor of the first exemplary embodiment.

### DETAILED DESCRIPTION OF THE INVENTION

The exemplary embodiments of the present invention are described hereinafter with reference to the accompanying drawings.

### First Exemplary Embodiment

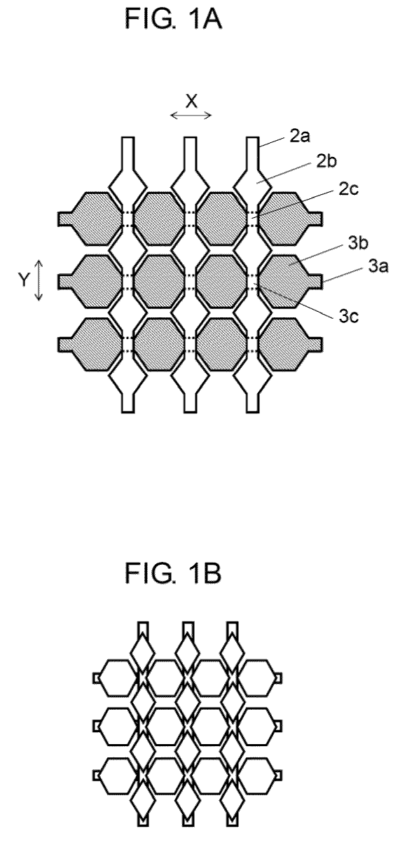

FIGS. 1A and 1B are plan views partially showing the conductor patterns of a capacitive touch sensor in accordance with the first exemplary embodiment. Specifically, FIG. 1A shows an actual pattern shape and FIG. 1B schematically shows the shape of the conductor patterns.

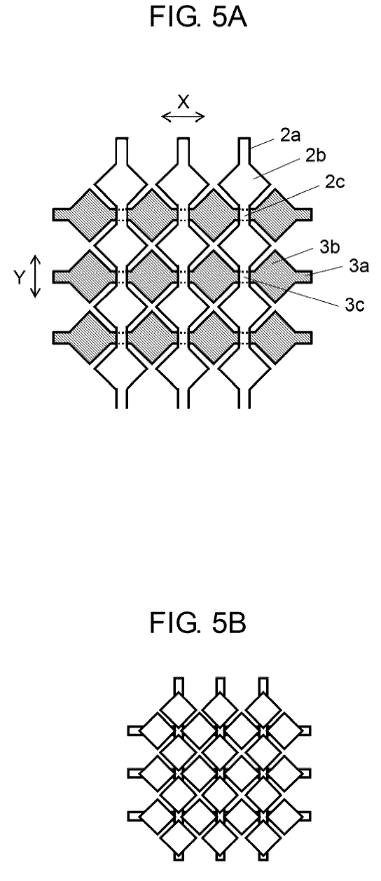

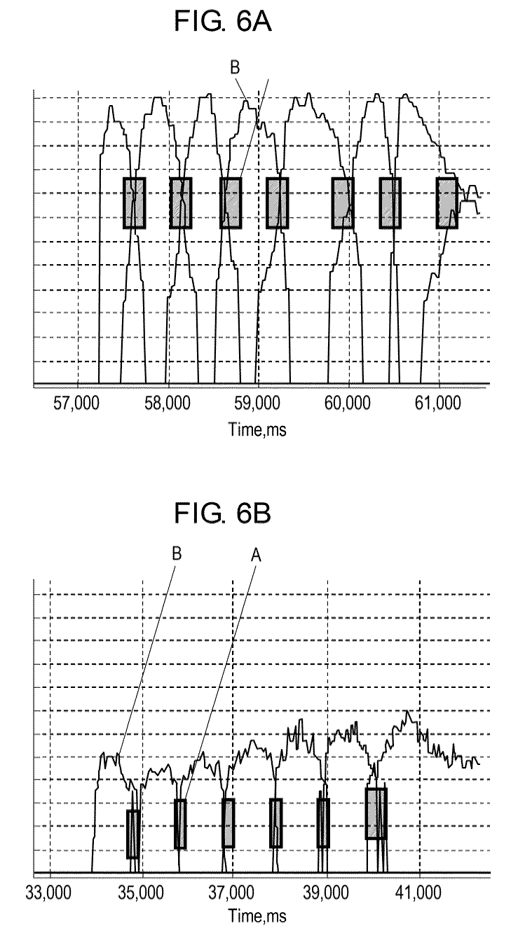

In FIG. 1A, like parts are identified by the same reference marks as in the conventional structure (shown in FIG. 5A). The capacitive touch sensor of the embodiment has a section similar to that of a conventional structure shown in FIG. 3, and the description thereof will be omitted.

A plurality of conductor patterns 3a is formed on transparent conductor pattern substrate 3. Conductor patterns 3a are arranged in parallel, and each of which has a plurality of parts 3b of a hexagonal shape. Similarly, a plurality of conductor patterns 2a is formed on transparent conductor pattern substrate 2. Conductor patterns 2a are arranged in parallel, and each of which has a plurality of parts 2b of a diamond shape. Employing the structure above allows parts 3b of conductor patterns 3a to be larger in area than parts 2b of conductor patterns 2a.

Hexagonal-shaped parts 3b are linearly connected by narrow joint parts 3c, and similarly, diamond-shaped parts 2b are linearly connected by narrow joint parts 2c. Conductor patterns 2a and conductor patterns 3a are disposed in an orthogonal arrangement so that each intersection of patterns 2a and 3a represents a position on a two-dimensional surface determined by the X and Y directions.

The position-detecting process of the capacitive touch sensor is similar to that of a conventional sensor. A finger-touch operation on the surface of protective cover 1 causes change in capacitance. Reading the change from each conductor pattern, the touch sensor detects a crossing position of the X and Y directions of the conductor patterns corresponding to the finger-touched position.

Conductor patterns 3a are disposed farther than conductor patterns 2a from the surface of protective cover 1 as the top layer. The difference in distance has conventionally caused variations in sensitivity between conductor patterns 2a and conductor patterns 3a. According to the structure of the embodiment, the area ratio of hexagon-shaped parts 3b (of conductor patterns 3a) to diamond-shaped parts 2b (of conductor patterns 2a) can be changed. For example, a combination of large-sized hexagons and small-sized diamonds or a combination of small-sized hexagons and large-sized diamonds may be employed for obtaining uniform sensitivity.

Unlike the conventional combination of squares, the combination of hexagons and diamonds allows the two conductor patterns to have an effective change in size. To be specific, in the combination of squares, an effective increase in size of part 3b is not expected under constraint of a fixed width of conductor pattern 3a. Therefore, to obtain uniform sensitivity, part 2b has to be decreased in size. As a result, the total area of parts 2b and parts 3b has to be decreased, by which the sensitivity of the sensor is degraded.

According to the structure of the embodiment, the gap between diamond-shaped part 2b and hexagon-shaped part 3b can be minimized by forming part 2b and part 3b in a manner that each side of the diamond is arranged in parallel to each side of the hexagon. In other words, the total area of the diamonds and the hexagons can be maximized.

Compared to the conventional structure where the area of part 2b is equal to that of part 3b, the area of part 2b of the embodiment has a slight decrease; however, conductor patterns 2a are disposed upper in the layered structure, and therefore the sensitivity thereof is maintained at a sufficient level.

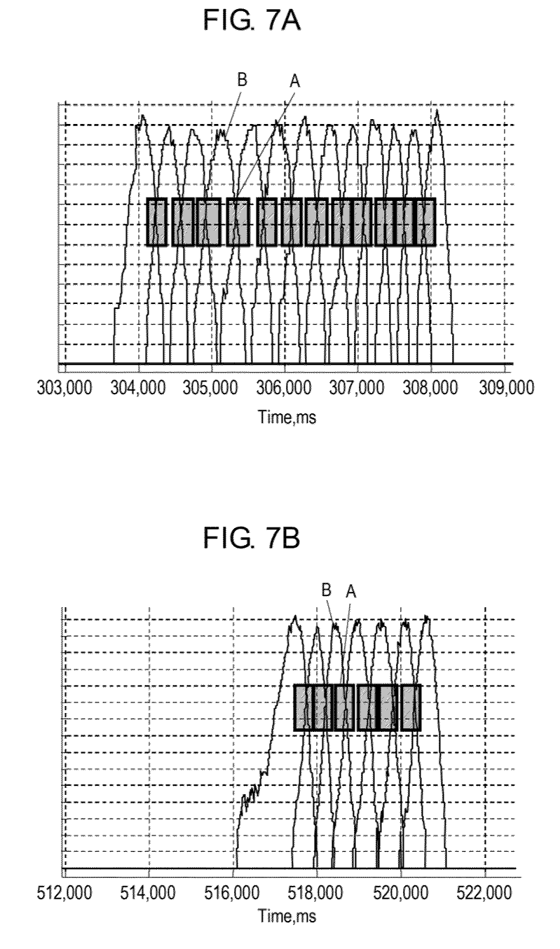

FIGS. 7A and 7B show changes in sensitivity in the X direction and in the Y direction, respectively, of the conductor pattern of the capacitive touch sensor of the embodiment shown in FIG. 1. Both the graphs show that capacitance level B of adjacent two sensors exhibits sufficient overlapped amount A. That is, both in the X direction and in the Y direction, the capacitance level between the two points have a sufficient overlap, contributing to coordinate calculation with accuracy.

As described above, the structure of the embodiment improves uniformity not only in transparency of the touch sensor but also in sensitivity of the conductor patterns disposed on different layers.

### Second Exemplary Embodiment

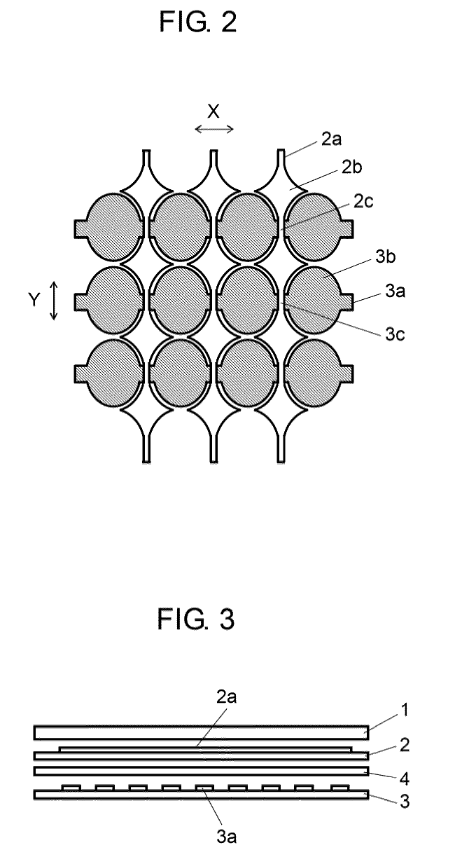

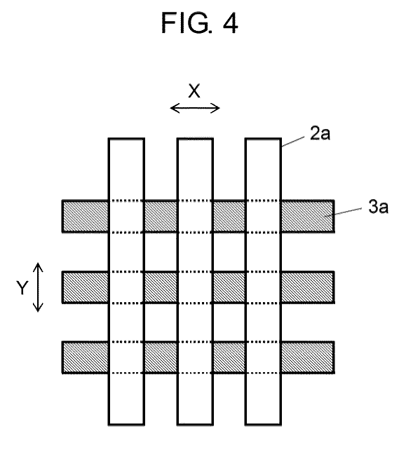

FIG. 2 is a plan view partially showing the conductor patterns of a capacitive touch sensor in accordance with the second exemplary embodiment of the present invention.

In FIG. 2, like parts are identified by the same reference marks as in the conventional structure and in the structure of the first embodiment. The capacitive touch sensor of the embodiment has a section similar to that of a conventional structure shown in FIG. 3, and the description thereof will be omitted.

A plurality of conductor patterns 3a is formed on transparent conductor pattern substrate 3. Conductor patterns 3a are arranged in parallel, and each of which has a plurality of circular parts 3b. Similarly, a plurality of conductor patterns 2a is formed on transparent conductor pattern substrate 2. Conductor patterns 2a are arranged in parallel, and each of which has a plurality of parts 2b of a diamond shape having four sides curved like an arc. Employing the structure above allows part 3b of conductor pattern 3a to be larger than part 2b of conductor pattern 2a. Diamond-shaped parts 2b are linearly connected by narrow joint parts 2c, and similarly, circular parts 3b are linearly connected by narrow joint parts 3c. Conductor patterns 3a and conductor patterns 2a are disposed in an orthogonal arrangement.

The position-detecting process of the capacitive touch sensor of the embodiment is similar to those of the conventional sensor and the sensor of the first embodiment. A finger-touch operation on the surface of protective cover 1 causes change in capacitance. Reading the change from each conductor pattern, the touch sensor detects a crossing position of the X and Y directions of the conductor patterns corresponding to the finger-touched position.

Conductor patterns 3a are disposed farther than conductor pattern 2a from the surface of protective cover 1 as the top layer. The difference in distance has conventionally caused variations in sensitivity between conductor patterns 2a and conductor patterns 3a. According to the structure of the embodiment, the area ratio of circular parts 3b (of conductor patterns 3a) to diamond-shaped parts 2b (of conductor patterns 2a) can be changed. For example, a combination of large-sized circles and small-sized diamonds or a combination of small-sized circles and large-sized diamonds may be employed for obtaining uniform sensitivity.

Unlike the conventional combination of squares, the combination of circles and diamonds allows the two conductor patterns to have an effective change in size.

According to the structure of the embodiment, the gap between diamond-shaped part 2b and circular part 3b can be minimized by forming part 2b and part 3b in a manner that each side of the diamond is curved along the perimeter of each circle. In other words, the total area of the diamonds and the circles can be maximized.

Compared to the conventional structure where the area of part 2b is equal to that of part 3b, the area of part 2b of the embodiment has a slight decrease; however, like the structure in the first embodiment, conductor patterns 2a are disposed upper in the layered structure, and therefore the sensitivity thereof is maintained at a sufficient level.

The capacitive touch sensor of the present invention, as described above, has the following features. Of the two conductor patterns in an orthogonal arrangement, the conductor pattern disposed farther from the top layer having finger-touch or pen-touch operation is larger than the conductor pattern disposed nearer to the top layer. This allows the two conductor patterns disposed on different layers to have uniform sensitivity. At the same time, the conductor patterns have a plurality of broadened parts of predetermined shapes; as a combination of hexagons and diamonds or a combination of circles and diamonds having four sides curved like an arc. Employing such formed conductor patterns not only improves uniformity in transparency of the touch sensor but also enhances the sensitivity of position detection as the X and Y coordinates of the conductor pattern.

In the descriptions above, the broadened parts are formed as a combination of hexagons and diamonds or a combination of circles and diamonds having four sides curved like an arc, but it is not limited thereto. The broadened parts of the conductor pattern disposed farther from the top layer having finger-touch or pen-touch operation may be formed into polygons (where, a barrel shape surrounded by two linear sides and two curved sides is included). In that case, the broadened parts of the other conductor pattern that is nearer to the top layer should be formed into a shape having sides being parallel (or conformed) to the sides of the polygon. Such structured conductor patterns are similarly effective.

In the exemplary embodiments, the capacitive touch sensor has a structure similar to the conventional one shown in FIG. 3. As another possibility, a single transparent conductive substrate can be served as conductor pattern substrates 2 and 3. In that case, a transparent conductor pattern film is formed on both surfaces of the transparent conductive substrate. In addition, the transparent conductive substrate should function as insulating sheet 4.

1. A capacitive touch sensor of a layered structure comprising:
a transparent upper member on which a finger or a pen touches;
a plurality of first transparent conductor patterns arranged in parallel;
a plurality of second transparent conductor patterns arranged in parallel positioned lower than the first transparent conductor patterns; and
a transparent insulating member disposed between the first transparent conductor patterns and the second transparent conductor patterns,
wherein the first transparent conductor patterns and the second transparent conductor patterns are disposed in an orthogonal arrangement so as to form a two-dimensional sensor, each of the first transparent conductor patterns and the second transparent conductor patterns has a plurality of broadened parts, and each of the broadened parts of the second transparent conductor patterns is larger than each of the broadened parts of the first transparent conductor patterns.

2. A capacitive touch sensor of a layered structure comprising:
a transparent upper member on which a finger or a pen touches; and
a transparent substrate further including:
a plurality of first transparent conductor patterns in a parallel arrangement disposed on one surface; and
a plurality of second transparent conductor patterns in a parallel arrangement disposed on the other surface, the second transparent conductor patterns positioned lower than the first transparent conductor patterns,
wherein the first transparent conductor patterns and the second transparent conductor patterns are disposed in an orthogonal arrangement so as to form a two-dimensional sensor, each of the first transparent conductor patterns and the second transparent conductor patterns has a plurality of broadened parts, and each of the broadened parts of the second transparent conductor patterns is larger than each of the broadened parts of the first transparent conductor patterns.

3. The capacitive touch sensor of claim 1, wherein each of the broadened parts of the second transparent conductor patterns is formed into a polygon and each of the broadened parts of the first transparent conductor patterns has a side being parallel to a side of the polygon.

4. The capacitive touch sensor of claim 3, wherein each of the broadened parts of the second transparent conductor patterns has a hexagonal shape, while each of the broadened parts of the first transparent conductor patterns has a diamond shape.

5. The capacitive touch sensor of claim 3, wherein each of the broadened parts of the second transparent conductor patterns has a circular shape, while each of the broadened parts of the first transparent conductor patterns has an approximately diamond shape with four sides of arc.

6. The capacitive touch sensor of claim 3, wherein each of the broadened parts of the second transparent conductor patterns has a barrel shape, while each of the broadened parts of the first transparent conductor patterns has an approximately diamond shape with four sides of arc.

7. The capacitive touch sensor of claim 2, wherein each of the broadened parts of the second transparent conductor patterns is formed into a polygon and each of the broadened parts of the first transparent conductor patterns has a side being parallel to a side of the polygon.
